(19) United States
(12) Patent Application Publication
(10) Pub. No.: US 2026/0321163 A1
(43) Pub. Date: Oct. 15, 2026

(54) SECURITY LABEL

(71) Applicants: Suresh Narayanan, Whittlesey (GB); Andrew Simon Jakes, Whittlesey (GB)

(72) Inventors: Suresh Narayanan, Whittlesey (GB); Andrew Simon Jakes, Whittlesey (GB)

(21) Appl. No.: 19/294,000

(22) Filed: Aug. 7, 2025

Related U.S. Application Data
(60) Provisional application No. 63/680,959, filed on Aug. 8, 2024.
(60) Provisional application No. 63/744,507, filed on Jan. 13, 2025.

(51) Int. Cl. G09F 3/03; G09F 3/02

(52) U.S. Cl. CPC G09F 3/0341; G09F 2003/0202; G09F 2003/0229; G09F 2003/023; G09F 2003/0267; G09F 2003/0269; G09F 2003/0272

(57) ABSTRACT

A security label for sealing bags or containers includes a label substrate with front and back sides. The label features horizontal perforations defining a tear strip, two adhesive strips on the backside for adhering to opposing side surfaces of a bag, and a central horizontal crease for folding. Vertical perforations allow variable label sizing. The label is joined to a liner substrate to form a label-liner combination producible in sheets, rolls, or fanfolds. The liner substrate includes a horizontal perforation that aligns atop a portion of one of the two adhesive strips. When the security label is removed from the liner substrate a portion of the liner substrate remains affixed to the backside of the label and is used as a handling component when affixing the label over an opening of a bag or container.

### RELATED APPLICATIONS

The present application is a non-provisional of Provisional Application Nos. 63/680,959 and 63/744,507. Provisional Application No. 63/680,959 was filed on Aug. 8, 2024 and entitled “Security Label;” Provisional Application Number 63/744,507 was filed on Jan. 13, 2025 and entitled “Security Label.” The disclosures of 63/680,959 and 63/744,507 are incorporated by reference herein in their entireties.

### BACKGROUND

In the food service and delivery industry, ensuring the integrity and security of carryout orders is of paramount importance. Customers and businesses alike have growing concerns about food safety, tampering, and unauthorized access to their orders during transit. Existing approaches to sealing carryout bags, such as simple adhesive stickers or staples, are often insufficient in providing clear evidence of tampering and can be easily compromised without detection. These techniques fail to offer the level of security and peace of mind that both consumers and businesses increasingly demand in today's market.

Additionally, current sealing techniques may not adequately address the need for tamper-evident solutions in other industries where secure packaging is critical, such as for important documents or sensitive items. There is a pressing need for an innovative sealing mechanism that not only secures the contents but also provides unmistakable evidence if the seal has been breached, thereby addressing the safety and security concerns prevalent in various industry sectors.

### BRIEF DESCRIPTION OF THE DRAWINGS

FIG. 1 is a diagram illustrating a security label, according to an example embodiment.

FIG. 2 is a diagram of a front side of the security label with a liner underneath the security label to form a liner-label combination, according to an example embodiment.

FIG. 3 is a diagram of a backside of the liner, according to an example embodiment.

FIG. 4 is a diagram of a backside of the security label, according to an example embodiment.

FIG. 5 is the backside of the security label when removed from the liner with a portion of the liner remaining on the backside of the security label, according to an example embodiment.

FIG. 6 is a diagram of a bag with the security label securing an opening of the bag, according to an example embodiment.

FIG. 7A is a diagram a larger bag with a larger security label securing and a larger opening of the bag, according to an example embodiment.

FIG. 7B is a side view of a bag with the security label folded but not yet adhered over an apex of an opening for the bag, according to an example embodiment.

FIG. 8 is a diagram of fanfold security labels, according to an example embodiment.

FIG. 9 is a diagram of a roll of the security labels, according to an example embodiment.

FIG. 10 is a flow diagram of a method for manufacturing the security label, according to an example embodiment.

### DETAILED DESCRIPTION

As used herein, the term and phrase “liner” and/or “liner substrate” may be used interchangeably and synonymously. Also, the phrases “face stock,” “label substrate,” and/or “label” may be used interchangeably and synonymously herein and below.

Existing tamper-evident or security labels often fall short in several key areas. Many current solutions rely on flood-coated adhesive, which is costly and wasteful. These labels frequently lack flexibility in sizing, making them unsuitable for a wide range of bag or container sizes. Additionally, some existing labels do not provide clear visual evidence of tampering, leaving room for doubt about the integrity of the sealed item.

The security label described in this invention addresses these shortcomings while offering several unique advantages. Its variable length design, achieved through evenly spaced vertical perforations, allows for a single label type to accommodate small, medium, and large bags or containers. This flexibility significantly enhances the label's versatility and reduces inventory complexity for businesses since multiple sized labels do not have to be stocked.

Unlike conventional flood-coated labels, this security label utilizes two strategically placed adhesive strips on its backside. This targeted approach not only reduces adhesive usage, making the label more cost-effective, but also simplifies the application process. A prefabricated horizontal crease or printed line ensures consistent and proper placement of the label over the bag's opening, further streamlining the sealing process.

The label's tear strip, defined by horizontal perforations, provides unmistakable evidence of tampering. Once the tear strip is removed, the label is permanently damaged, offering immediate visual confirmation to the recipient if the bag or container has been compromised. This feature addresses the critical need for clear tamper evidence in various industries, from food delivery to sensitive document or item transport.

Furthermore, the label's design allows for efficient manufacturing in rolls, fanfolds, or individual sheets, providing flexibility in production and storage. The minimal use of adhesive not only reduces costs but also minimizes environmental impact compared to flood-coated alternatives.

The handling of adhesive labels after removal from their liner presents significant challenges in packaging applications. Conventional labels with full adhesive backing tend to fold and adhere to themselves, making separation and application difficult. This problem is particularly pronounced with larger labels, which become unwieldy due to their lack of structural support and adhesive properties.

The present invention addresses these challenges through an innovative label-liner design. The label features two narrow adhesive strips on its backside, while the liner includes a horizontal die cut spanning its width. This die cut is precisely aligned to overlap with the bottom portion of one adhesive strip. When the label is separated from the liner, a portion of the liner remains temporarily attached to the label's backside through this strategic adhesive placement.

This design creates a handling zone free of adhesive, allowing for easier manipulation of the label before application. Additionally, the attached liner portion provides enhanced structural stability and rigidity to the upper section of the label, making it significantly easier to handle and apply to bags or other packaging materials.

In summary, this innovative security label represents a significant advancement in label design and functionality. The solution elegantly combines enhanced handling characteristics with practical security features. The temporary liner attachment on the label's backside provides crucial structural integrity during application, while maintaining optimal flexibility. This design not only streamlines the application process but also delivers robust tamper-evident capabilities.

The label's innovative engineering addresses traditional challenges while delivering multiple advantages: simplified handling, versatile application options, optimized manufacturing processes, and reduced environmental impact. This comprehensive approach results in a cost-effective solution that exceeds conventional label performance standards while meeting modern packaging security requirements.

In the discussion of the FIGS. that follow a variety of label sizes and/or dimensions are illustrated. The sizes and/or dimensions represent one embodiment of the security label. Notably, the label's sizes and dimensions are configurable based on the intended application and/or needs of a customer and their bags and/or containers requiring the security and tamper evident label described herein.

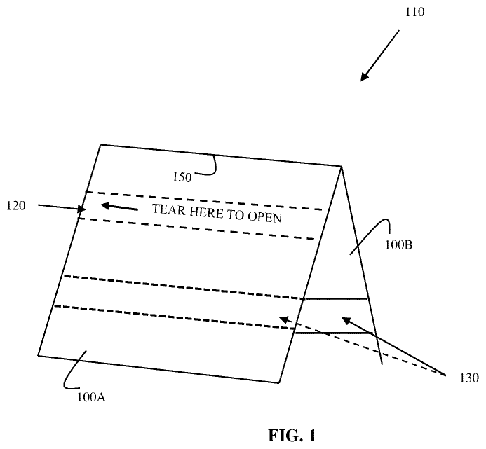

FIG. 1 illustrates a security label 110 comprising a front side 100A and a backside 100B. The label 110 includes a horizontal prefabricated crease 150 positioned substantially at the center of the label 110. This crease, which may be formed through folding, printing, or thermal imaging, serves as a visual guide for the user. The crease divides the label 110 into two substantially equal portions, enabling precise folding when applying the label over a bag, container, or package opening to provide tamper-evident security.

The first portion of the folded label 110 incorporates dual horizontal die cuts or perforations that define a tear strip 120. The designation “120” encompasses the tear strip area, the two horizontal die cuts, and any instructional text or images contained within this region.

When the label 110 is folded along crease 150 and positioned over a bag or container opening's apex, two adhesive strips 130 enable secure adhesion to opposing surfaces of the bag. These adhesive strips 130 are strategically positioned on the backside 100B of label 110, with each strip 130 located proximally to an end of the label 110. For clarity, FIG. 1 depicts the backside adhesive strips 130 on the visible front side through condensed dotted lines, indicating their actual placement on the label's reverse side.

In an embodiment, the label substrate 110 is paper or filmic with a grammage from 50 to 300 gsm and caliper from 50 to 300 micron. In an embodiment, the adhesive strips 130 include a solvent acrylic adhesive, an emulsion acrylic (e.g., solvent-free water base), a rubber based or hotmelt adhesive, an acrylic hotmelt adhesive, or an ultraviolet (UV) acrylic hotmelt adhesive. In an embodiment, the adhesive strips 130 include a mixture of different types of adhesive.

In an embodiment, the front side 100A of the label 110 includes a print coating. In an embodiment, the print coating is a thermally sensitive ink coating (e.g., direct thermal or thermal transfer), a dot matrix ink coating, or a laser ink coating permitting a printer to image custom indicia on the front side 100A of the label 110.

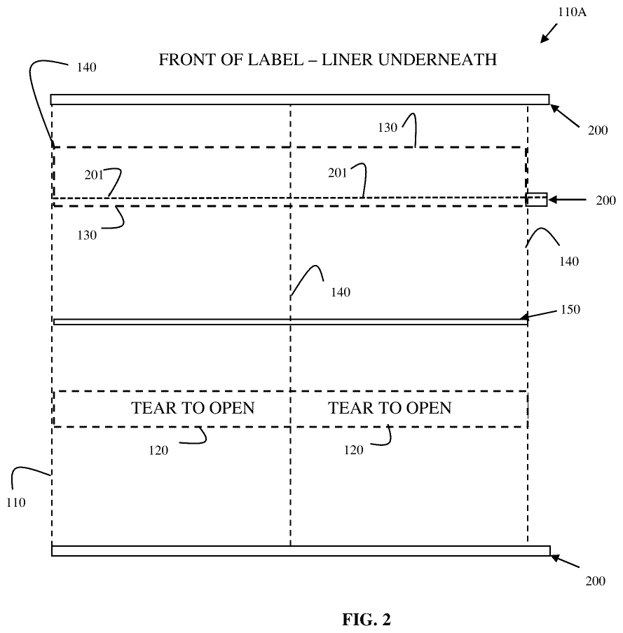

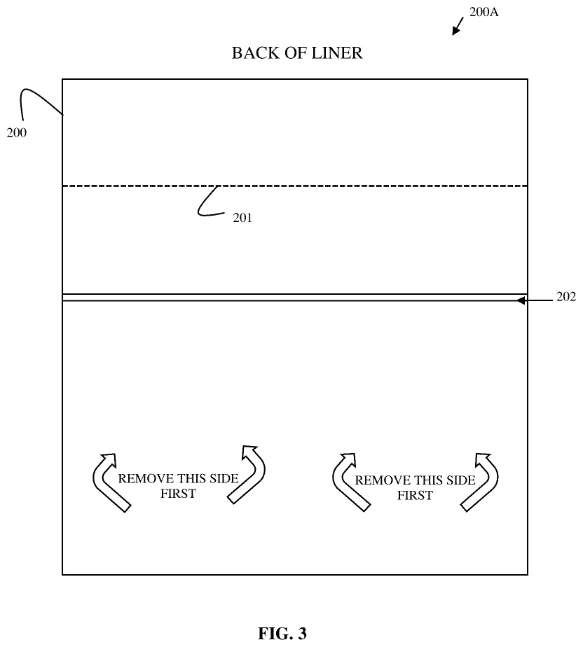

The label 110 further includes a liner 200, shown and discussed below with FIGS. 2 and 3. The backside 100B of the label 110 is joined and adhered to a front side of the liner 200 to form a label-liner combination. The label-liner combination is manufactured in sheets form, roll form, and/or fanfold form. In an embodiment, the liner 200 is paper or film with a grammage of 15 to 100 gsm and caliper of 12 to 100 micron.

FIG. 2 is a diagram of the front side 100A of label 110 with a liner 200 affixed underneath the label 110 to form a label-liner combination, according to an example embodiment. In an embodiment, and as illustrated in FIG. 2, the top and bottom of the liner 200 extends beyond the top and bottom of the label 110 by a gap length of gap height of approximately 3 mm. The illustrated depiction in FIG. 2 shows the front side of the label 110 with the liner 200 affixed to the backside of the label 110 such that primarily just the front side of the label 110 is visible. Some structural components of both the backside of the label 110 and the liner are illustrated in FIG. 2 via dotted lines.

In an embodiment, the width or height of the crease 150 is approximately 2 mm. In an embodiment, the width or the height of the tear strip 120 is approximately 10 mm. In an embodiment the height of the label 110 is approximately 150 mm.

The label 110 includes one or more vertical die cuts or perforations 140 extending for the height of the label 110. Each pair of vertical perforations 140 represent a minimal and predefined width that the label 110 can be cut into. In an embodiment, the minimal and predefined width is approximately 100 mm. The label 110 can be variably sized by cutting along a centerline of middle perforation 140; for example, the label 110 illustrated in FIG. 2 is 200 mm in width and includes three perforations 140. Notably, the label 110, as illustrated in FIG. 2, can be sized from 100 mm in width to 200 mm in width. Because label 110 is variably sized, label 110 can fit over bags or different sizes and sized according to the application.

FIG. 3 is a diagram of a backside 200A of the liner 200, according to an example embodiment. Liner 200 also includes a single horizontal die cut 201 made through the liner substrate to define a handling component identified by the area extending up from the die cut 201 to the top and corresponding sides of liner 200. The handling component remains temporarily affixed to the backside of the liner 200 when a user or an applicator of a printer separates the label 110 from the liner 200 for application.

In an embodiment, the backside 200A of the liner 200 includes a printed/thermally imaged graphic and/or text that illustrates to a user that the liner 200 should be peeled away from the label 110 from a bottom of the liner 200. That is, the user should peel the liner 200 off the label from the farthest end of the liner relative to the liner die cut 201.

When the user removes the label 110 from the liner 200, a portion of the liner defined above die cut 201 remains securely affixed to the label's backside. This retained liner segment strategically covers one of the two adhesive strips 130 on the label's reverse surface, creating an adhesive-free handling zone at the top of the label-liner assembly.

This design enables efficient two-handed application: The user can grasp the adhesive-free top portion while using their other hand to apply the exposed bottom adhesive strip 130 to the bag or container surface. Once the bottom portion is securely attached, the user can then remove the remaining liner segment from the top section and affix the newly exposed adhesive strip 130 to the opposite side of the container, completing the application process.

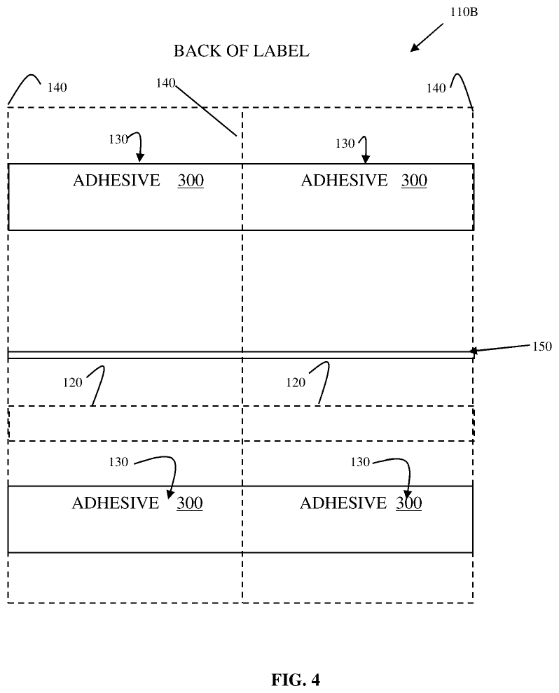

FIG. 4 is a diagram of the backside 100B of the security label 110, according to an example embodiment. In an embodiment, and as illustrated in FIG. 2, the top and bottom of the liner 200 extends beyond the top and bottom of the label 110 by a gap length of gap height of approximately 3 mm. In an embodiment, the crease 150 is approximately 2 mm in height or width. In an embodiment, the label can be variably sized in increments of approximately 100 mm using vertical perforations 140 as discussed above in FIG. 2. FIG. 4 illustrates just the backside of label 110 without the liner 200 being illustrated.

The backside 100B of the label 110 includes two adhesive strips 130. In an embodiment, each strip 130 includes an adhesive strip of approximately 20 mm in height or width. Each strip 130 is proximate to and/or adjacent to a particular end (i.e., top or bottom) of the label 110 along the backside 100B allowing ends of the label 110 to be adhered to opposing side surfaces of a bag with the crease 150 folded over an apex of an opening for the bag.

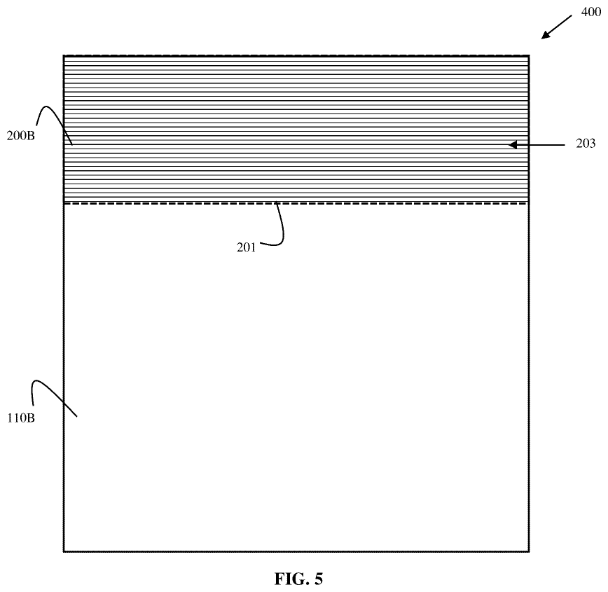

FIG. 5 is the backside 110B of the security label 110 when removed from the liner 200 with a portion 203 of the liner 200 remaining on the backside 110B of the security label 110, according to an example embodiment. Portion 203 provides an adhesive free handling component 203 when affixing the label 110 over an opening of a bag or container. Furthermore, handling component 203 provides weight and structural rigidity to the label 110 during label application. The area of the remaining liner 200 affixed to the backside 110B of label 110 extends up from liner die cut 201 and extends slightly beyond a top of the label 110, as illustrated and was discussed in FIG. 2 above. This extension of the top of the handling component 203 beyond a top of liner 110 provides a tab for the user to separate the handling component 203 from the label 110 to adhere the corresponding adhesive strip 130 to a side of the bag or container.

The backside 110B of the label 110 also shows the crease 150 along a center line of the label 110. The crease 150 permits the label 110 to be folded by the user into two equal halves before affixing the label 110 to a bag or container.

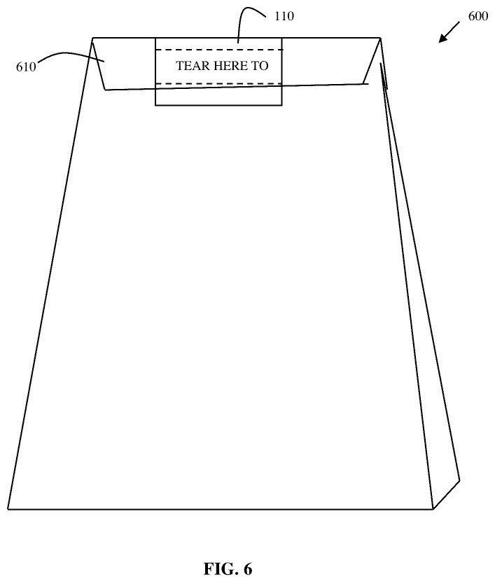

FIG. 6 is a diagram of a bag 600 with the security label 110 securing an opening 610 of the bag 600, according to an example embodiment. The crease 150 of the label 110 is folded over an apex of the opening 610 and each adhesive strip 130 adhered to an opposing side of the bag 600 to securely affix the label 110 over the opening 610 and seal the bag 600 shut.

In an embodiment, the front side 100A of the label 110 corresponding to the tear strip 120 includes preprinted indicia providing instructions to a recipient of the bag 600 to “Tear Here to Open” the sealed bag 600. In an embodiment, the preprinted indicia also includes an arrow image that points in the direction that the tear strip 120 is to be removed from the label 110. The illustrated bag 600 and label 110 of FIG. 6 shows a label 110 having a width of approximately 100 mm or a minimal predefined width.

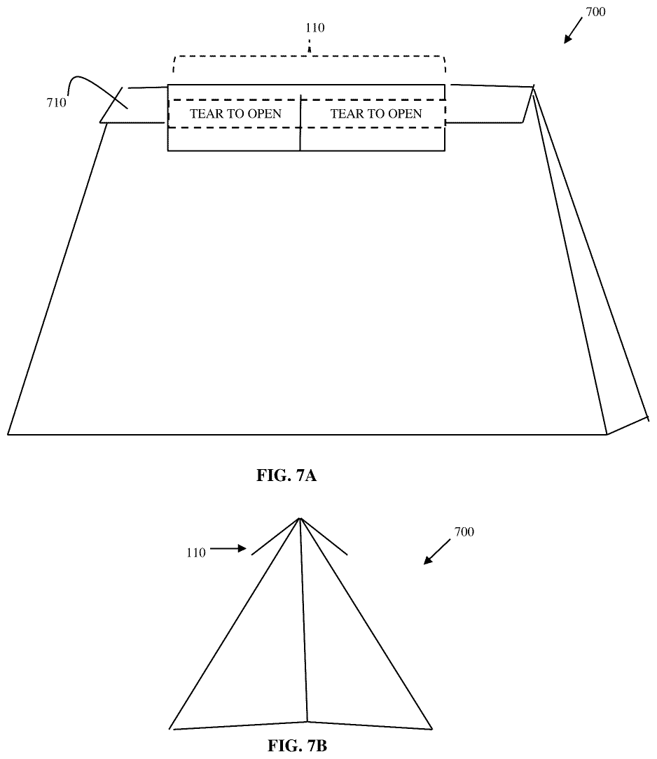

FIG. 7A is a diagram a larger bag 700 with a larger security label 110 securing and a larger opening 710 of the bag 700, according to an example embodiment. The label 110 illustrated in FIG. 7A is approximately 200 mm in width to twice the size as was illustrated in FIG. 6 with bag 600. FIG. 7A is intended to illustrate that label 110 can be variably sized and fitted to a bag of any size.

FIG. 7B is a side view of a bag 700 with the security label 110 folded but not yet adhered over an apex of an opening 710 for the bag 700, according to an example embodiment. The adhesive strips 130 along the backside 100B of the label 110 have not been pressed against the top side surfaces of the bag 700 to adhere the label 110 to the bag 700 and seal an opening 710 of the bag 700 via label 110. Crease 150 permits the label 110 to be folded at the apex of the opening 710 for the bag 700 and then the two separate portions of the label 110 corresponding to the adhesive strips 130 pressed against opposing sides of the bag 700 to seal the opening 710 of the bag 700 shut.

When the tear strip 120 is removed from a label 110 sealed over an opening 710 of the bag 700, the opening 710 is freed from the label 110 and can be opened by the intended recipient of the bag 700. However, the original label 110 is incapable of being reassembled or reattached. A backside of the label 110 corresponding to the freed tear strip 120 does not include adhesive such that the label 110 is permanently separated into three distinct portions including a first portion remaining adhered to a first side surface of the bag 700, a second portion remaining adhered to a second and opposing side surface of the bag 700, and the separated tear strip 120 as a third portion.

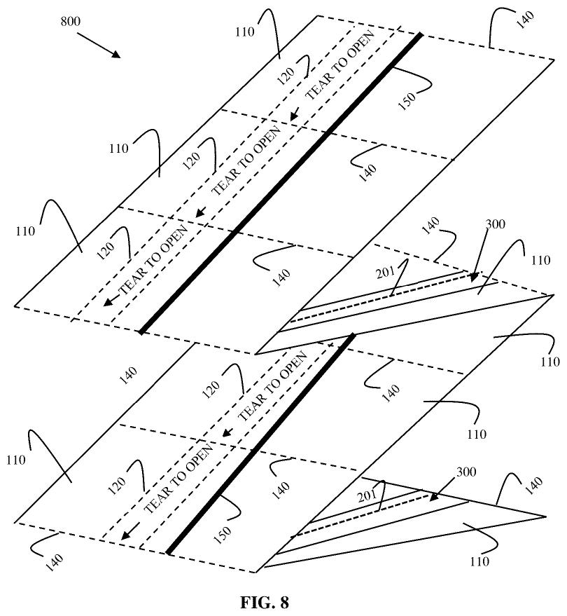

FIG. 8 is a diagram of fanfold 800 security labels 110, according to an example embodiment. The fanfold 800 illustrated includes a plurality of security labels 110 folded along a perforation 140 in groups of 3. Again, the security labels 110 can be variably sized as one, two, or three labels by cutting along a desired vertical perforation 140. A box of the fanfold 800 security labels 110 can be placed in front of a printer or applicator and fed directly to the printer or applicator for custom imaging and/or dispensing for application.

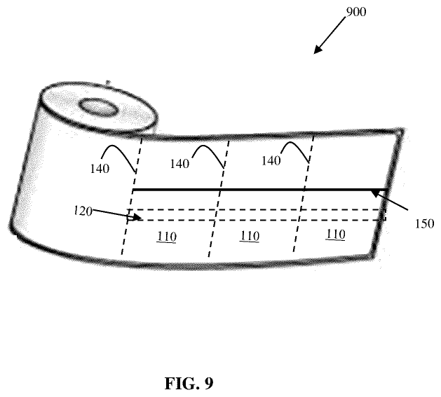

FIG. 9 is a diagram of a roll 900 of the security labels 110, according to an example embodiment. The roll 900 illustrated shows the individual labels 110 defined by perforations 140 and with the corresponding creases 150 and tear strips 120 defined within web of the roll 900. Again, a given dispensed label 110 can be variably sized to include just one label 110 of a minimal preconfigured width or to include two or more labels 110 of two or more minimal preconfigured widths as a single larger dispensed label 110.

In an embodiment, the backside 100B of the label 110 further includes a printed sense mark adjacent to each of the vertical perforations 140. This permits a printer to identify the vertical perforations 140 or multiple ones of the vertical perforations to cut the variable sized labels 110 from the roll 900.

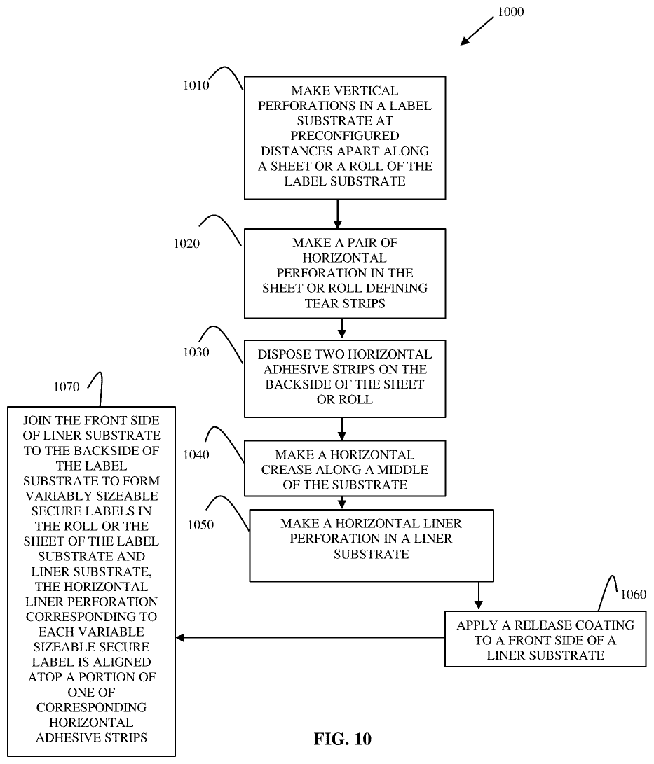

FIG. 10 is a diagram a method 1000 for manufacturing the security label 110, according to an example embodiment. The method 1000 is processed by a press at stations with the electro mechanical components of the press controlled by firmware or software.

At 1010, a station of the press, makes vertical die cuts or perforations 140 in a label substrate at preconfigured distances apart along a sheet or a roll of the label substrate. Each preconfigured distance representing a minimal width for an individual security label 110 being defined within the sheet or roll.

At 1020, a station of the press, makes a pair of horizontal die cuts or perforations in the label substrate. The perforations define a tear strip 120 for each security label 110 being defined within the sheet or roll.

At 1030, a station of the press applies two horizontal adhesive strips 130 of adhesive across a backside 100B of the label substrate for an individual security label 110 being defined within the sheet or the roll. Each adhesive strip 130 of the two adhesive strips is proximally placed adjacent to a different end of the label substrate.

At 1040, a station of the press makes a horizontal crease 150 along a middle of the label substrate.

At 1050, a station of the press makes a horizontal liner perforation in a liner substrate.

At 1060, a station of the press applies a release coating to a front side of a liner substrate.

At 1070, a station of the press joins the front side of the liner substrate to the backside 100B of the label substrate to form variably sizable secure labels in the roll or sheet of the label substrate. The horizontal liner perforation corresponding to each variable sizeable secure label is aligned atop a portion of one of the corresponding horizontal adhesive strips.

Although the present invention is described with reference to certain preferred embodiments thereof, variations and modifications of the present invention can be affected within the spirit and scope of the following claims.

1. A security liner-label combination, comprising:
a label substrate;
a liner substrate;
a pair of horizontal label perforations made in the label substrate defining a tear strip;
two adhesive strips on a backside of the label substrate, each adhesive strip proximally situated adjacent to an end of the label substrate;
a horizontal liner die cut made in the liner substrate; and
horizontal creases situated substantially in center of the label substrate and the liner substrate;
wherein the backside of the label substrate is joined to a front side of the liner substrate with the horizontal liner die cut aligned to a bottom portion of a particular one of the two adhesive strips.

2. The security liner-label combination of claim 1, wherein a portion of the liner substrate defined above the horizontal liner die cut remains affixed to a corresponding backside portion of the label substrate when the liner substrate is peeled away from the label substrate.

3. The security liner-label combination of claim 1, wherein liner sides of the liner substrate extend past outer sides of the label substrate when the label substrate and the liner substrate are joined to form the security liner-label combination.

4. The security liner-label combination of claim 1, wherein the label substrate, when affixed to an opening of a bag and after subsequent removal of the tear strip, provides visual evidence of access through permanent separation of the label substrate into three distinct pieces.

5. The security liner-label combination of claim 1, wherein the label substrate includes one or more vertical perforations extending for a height of the label substrate, each pair of vertical perforations representing a minimal and predefined width that the security liner-label combination can be sized and cut into.

6. The security liner-label combination of claim 1, wherein each of the two adhesive strips has a width of approximately 20 mm.

7. The security liner-label combination of claim 1, wherein the horizontal creases are approximately 2 mm in width.

8. The security liner-label combination of claim 1, wherein the tear strip is approximately 10 mm in width.

9. The security liner-label combination of claim 1, wherein a front side of the label substrate includes preprinted indicia providing instructions to tear the tear strip to open a sealed container.

10. The security liner-label combination of claim 1, wherein the two adhesive strips comprise at least one of: a solvent acrylic adhesive, an emulsion acrylic adhesive, a rubber based adhesive, a hotmelt adhesive, an acrylic hotmelt adhesive, or an ultraviolet acrylic hotmelt adhesive.

11. A roll of security liner-label combinations, comprising:
a liner web comprising a liner die cut made in the liner web; and
a label web comprising:
vertical perforations at preconfigured distances apart, each preconfigured distance representing a minimal width for an individual security label;
a pair of horizontal perforations defining a tear strip for each individual security label;
two horizontal adhesive strips on a backside of the label web for each individual security label, each adhesive strip proximally placed adjacent to a different particular vertical perforation, and
a horizontal crease along a middle of the label web for each individual security label;
wherein a backside of the label web is aligned and joined to a front side of the liner web such that the liner die cut aligns and overlaps with portions of one of the two horizontal adhesive strips for each individual security label.

12. The roll of security liner-label combinations of claim 11, wherein a portion of a corresponding liner web remains affixed to a backside of a corresponding label when the corresponding label is separated from the liner web.

13. The roll of security liner-label combinations of claim 11, wherein each individual security label and corresponding liner web are variably sized for each security liner-label combination of the roll by cutting along one or more of the vertical perforations when a corresponding individual security liner-label combination is dispensed from the roll.

14. The roll of security liner-label combinations of claim 11, wherein the backside of the label web further includes a printed sense mark adjacent to each of the vertical perforations to permit identification of the vertical perforations for cutting variable sized labels from the roll.

15. The roll of security liner-label combinations of claim 11, wherein the liner web extends beyond top and bottom edges of the label web by approximately 3 mm.

16. The roll of security liner-label combinations of claim 11, wherein a front side of the label web includes a print coating selected from: a thermally sensitive ink coating, a dot matrix ink coating, and a laser ink coating.

17. The roll of security liner-label combinations of claim 11, wherein the liner web has a grammage of 15 to 100 gsm and a caliper of 12 to 100 micron.

18. A method comprising:
making vertical perforations in a label substrate at preconfigured distances apart along a sheet or roll of the label substrate;
making a pair of horizontal perforations in the label substrate defining tear strips within the sheet or the roll;
disposing two horizontal adhesive strips on a backside of the sheet or the roll;
making a horizontal crease along a middle of the sheet or the roll;
making a horizontal liner perforation in a liner substrate;
applying a release coating to a front side of the liner substrate; and
joining the front side of the liner substrate to the backside of the label substrate to form variable sizeable secure labels in the sheet or the roll of the label substrate and liner substrate, wherein the horizontal liner perforation corresponding to each variable sizeable secure label is aligned atop a portion of one of corresponding horizontal adhesive strips.

19. The method of claim 18, wherein a front side of the label substrate comprises a print coating.

20. The method of claim 19, wherein the print coating is a thermally sensitive ink coating, a dot matrix ink coating, or a laser ink coating.
